(19) United States
(12) Patent Application Publication
(10) Pub. No.: US 2009/0174661 A1
(43) Pub. Date: Jul. 9, 2009

(54) GESTURE BASED MODELING SYSTEM AND METHOD

(75) Inventors: Richard Rubinstein, Arlington, MA (US); Peter Robert Long, Arlington, MA (US)

Correspondence Address: WILMERHALE/BOSTON, 60 STATE STREET, BOSTON, MA, 02109, US

(73) Assignee: KALIDO, INC., Burlington, MA (US)

(21) Appl. No.: 12/245,026

(22) Filed: Oct. 3, 2008

Related U.S. Application Data
(60) Provisional application No. 60/997,852, filed on Oct. 5, 2007.

(51) Int. Cl. G06F 3/033; G09G 5/00

(52) U.S. Cl. 345/163; 345/156

(57) ABSTRACT

Described is a method and system for creating model components, such as business model components, using gestures that are input to a computer system. In an exemplary embodiment, the gestures are input to a computer system with a mouse device, but in general the gestures can be input via any suitable information input device. The gestures have at least three attributes. First, the gesture is orientation sensitive. This requires that the meaning of the gesture depends on the direction in which the gesture is made. Second, the gesture is context sensitive. This requires that the meaning of the gesture depends on the starting point and the ending point of the gesture. Third, the gesture is coincident input sensitive. This requires that the meaning of the gesture depends on the state of additional input from the user.

### CROSS REFERENCE TO RELATED APPLICATIONS

This application claims benefit of U.S. Provisional Patent Application Ser. No. 60/997,852, filed Oct. 5, 2007, which is hereby incorporated by reference in its entirety.

### BACKGROUND OF THE INVENTION

The present invention relates to user interfaces for computers and, more particularly, to using simple stroke-based gesture mechanisms for creating models represented in a graphical notation.

Computer aided software engineering (CASE) tools have been available for at least two decades. Among other applications, such tools can be used to create graphical representation of models in a standard notation, using a graphical user interface. One notation that is well-known in the art is the Unified Modeling Language (UML).

Examples of existing CASE tool products include “Rational Rose” and “MagicDraw,” although other similar tools are also available. Such products typically rely on user input from a two button mouse or similar device.

U.S. Pat. No. 7,096,454 provides an example of a prior-art gesture-based modeling method. The '454 patent describes a method that allows a user to specify a particular model element by inputting a gesture into a computer system that approximates the “shape” of the desired model element. However, the technique described in the '454 patent suffers from a number of drawbacks. For example, if the user does not accurately execute the desired gesture, the computer can erroneously translate the gesture into the wrong model element. Similarly shaped model elements therefore require the user to be relatively skilled at executing drawings.

### SUMMARY OF THE INVENTION

The described embodiments include a method and system for creating model components, such as business model components, using gestures that are input to a computer system. In an exemplary embodiment, the gestures are input to a computer system with a mouse device, but in general the gestures can be input via any suitable information input device. The gestures have at least the following three attributes:

The gesture is orientation sensitive. This requires that the meaning of the gesture depends on the direction in which the gesture is made. For example, a gesture that traverses left to right has a different meaning from a gesture that traverses right to left. (A richer set of gestures can be supported by including the vertical direction, top to bottom and vice versa. The horizontal and vertical directions can be combined so that diagonal gestures can also be recognized).

The gesture is context sensitive. This requires that the meaning of the gesture depends on the starting point and the ending point of the gesture, as well as what object the gesture traverses. For example, a gesture that starts and ends in an open space in the drawing canvas has a different meaning than a gesture that starts in a first previously instantiated object and ends in a second previously instantiated object.

The gesture is coincident input sensitive. This requires that the meaning of the gesture depends on the state of additional input from the user. For example, a gesture by itself has a different meaning from the same gesture made while holding down the ALT key.

The described embodiments provide a number of useful advantages. For example, the gestures are simple. They are easy to learn and self-teaching. Further, the described embodiments are efficient for specifying models because although the gestures used as input are simple and quick, a substantial amount of information is captured in each gesture due to multiple dimensions of specification (e.g., object, location, etc.). The described embodiments utilize a hand-eye feedback loop, enhanced by a well-designed graphical interface.

In one aspect, the described embodiments include a method of using a computer readable gesture to create a model presented in a display area. The method includes performing the gesture such that two or more characteristics associated with the gesture are input to a computer along with the gesture. At least one of the characteristics includes a context of the gesture with respect to objects within the display area, and at least one of the characteristics includes an orientation of the gesture with respect to the display area. The method further includes mapping, by the computer, the gesture and the two or more characteristics to one or more model elements. The method also includes creating the model by accumulating the one or more model elements, wherein the model conforms to a meta-model, and presenting the model in the display area. In one embodiment, the model is a business model.

In one embodiment, the method further includes providing at least one additional input to the computer while performing the gesture, and mapping the at least one additional input to the at least one model attribute along with the gesture and the two or more characteristics.

In another embodiment, the method further includes performing the gesture with an information input device. In one embodiment, the information input device is a mouse.

In one embodiment, presenting the model in the display area further includes rendering each view element within a view in the display area.

In another embodiment, the view element representation of the model includes at least one of position, color, texture, shading and shape of constituent diagrammatic elements of the view element representation.

In yet another embodiment, the view element representation of the model includes information relating to the corresponding model such as a unique name or an appearance characteristic.

In another embodiment, the mapping further includes determining context of a start location and an end location, and establishing a relationship between elements of the model according to the context.

One embodiment further includes performing at least one additional gesture, and mapping the gesture, the additional gesture, and the two or more characteristics to an alternative model attribute for use in creating the model.

In another aspect, the described embodiments include a system for creating a model from a computer readable gesture performed by a user, and presenting the model in a display area. The system includes a computing device having at least a processor, a display, and a memory device. The system further includes an input device with which the user performs the gesture. The input device provides two or more characteristics associated with the gesture to the computing device along with the gesture. At least one of the characteristics includes a context of the gesture with respect to objects within the display area, and at least one of the characteristics includes an orientation of the gesture with respect to the display area. The computing device maps the gesture and the two or more characteristics to at one or more model elements. The computing device creates the model by accumulating the one or more model elements, such that the model conforms to a meta-model. The computing device further presents the model in the display area.

One embodiment further includes an additional input device for accepting at least one additional input from the user to the computer while performing the gesture. The computing device maps the at least one additional input to the at least one model attribute along with the gesture and the two or more characteristics. In one embodiment, the user performs the gesture with an information input device. In one embodiment, the information input device is a mouse.

In another embodiment, the computing device presents the model in the display area by rendering each view element within a view in the display area. In one embodiment, the view element representation of the model includes at least one of position, color, texture, shading and shape of constituent diagrammatic elements of the view element representation. In another embodiment, the view element representation of the model includes information relating to the corresponding model such as a unique name or an appearance characteristic.

In one embodiment, the computing device further determines context of a start location and an end location, and establishes a relationship between elements of the model according to the context.

In another embodiment, the computing device further receives at least one additional gesture, and maps the gesture, the additional gesture, and the two or more characteristics to an alternative model attribute for use in creating the model.

### BRIEF DESCRIPTION OF DRAWINGS

The foregoing and other objects of this invention, the various features thereof, as well as the invention itself, may be more fully understood from the following description, when read together with the accompanying drawings in which:

FIG. 1 illustrates the relationship between the view and model and the elements that they each contain.

FIGS. 2A-2C illustrate the relationship between a Model Element and its View Element Representation for one particular proprietary business model notation.

FIG. 3A illustrates the gesture for creating a class within a model.

FIG. 3B illustrates the gesture for creating a transaction within a model.

FIG. 4 shows eight different gesture stroke orientations.

FIGS. 5A and 5B illustrate a particular gesture context creating an association between two classes.

FIG. 6 shows an involution association identified.

FIG. 7 shows an example of a computer upon which the described embodiments are implemented.

FIG. 8 shows relationships, as in FIGS. 2A-2C, for business process and or workflow models.

### DESCRIPTION OF THE PREFERRED EMBODIMENTS

The embodiments described herein adopt a gesture based mechanism for creating a graphical representation of a model and its underlying definition. The exemplary descriptions herein are directed to a business model in particular, although the concepts embodied in those examples are applicable to other types of models.

Each gesture typically consists of a single stroke (although compound strokes can also be used), which a computer then interprets through various characteristics of the stroke (e.g., parameters associated with the stroke), such as the orientation of the stroke, the context of its start and end location, the state of associated input keys, and constraints imposed by an underlying business model meta-model, among others. The gesture (or multiple gestures combined) and associated characteristics are mapped by the computer to create one or more model elements. The computer creates the model by incorporating the model elements into the model, such that the model conforms to an underlying meta-model. The computer then presents the model in a display area.

### Models and Views

A typical software structure, adopted for graphical modeling, is set forth below. This structure provides a framework for describing the graphical elements in the diagram area (i.e., a display area in which the user instantiates the desired model components), along with the correspondence of those elements to the underlying model that they represent. The structure is used to describe how gestures are interpreted, and how the corresponding graphical and model elements are created.

In business modeling, a user typically wishes to create a diagram containing rectangles and interconnected lines that correspond to one or more business aspects, such as elements of an organizational chart or steps in a business process. The visual style of the rectangles on the diagram vary to convey the different semantics, based on (i.e., conforming to) a meta-model, of the model elements the rectangles are intended to represent. The appearance and semantics of interconnecting lines is dependent upon the type of rectangle being connected, and also on properties or attributes of the model element that the line represents. The diagram typically includes common diagrammatic conventions including UML, and may also include proprietary conventions such as modeling notation adopted specifically for representing particular types of models (e.g., business models).

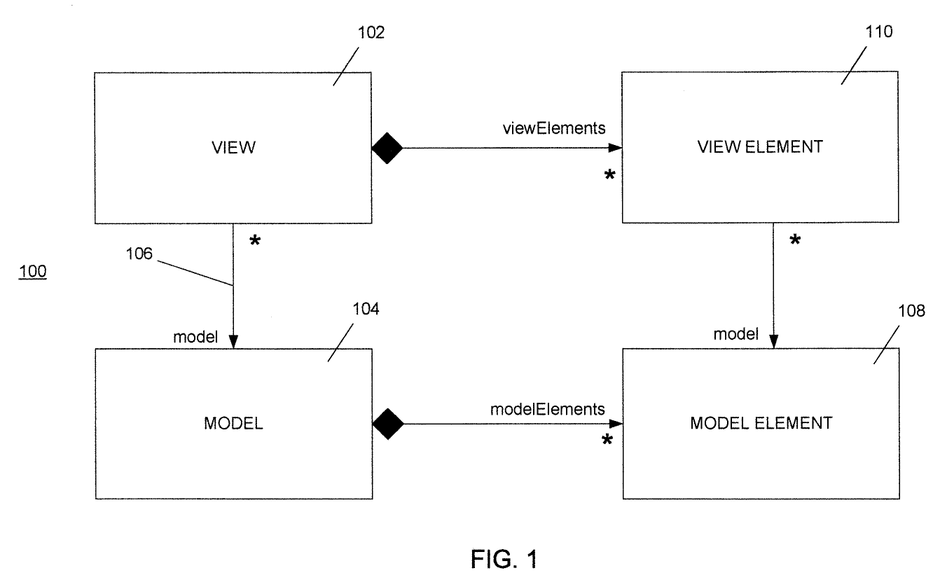

Typically in the development of graphical modeling computer software, the Model-View-Controller (MVC) design pattern is adopted (see, for example, http://en.wikipedia.org/wiki/Model-view-controller). In the described embodiment, the view is used to convey a visual representation of an underlying model. One or more view elements in the view correspond to one or more elements in the model. The UML class diagram 100 shown in FIG. 1 illustrates the relationship between the view and model and the elements that they each contain. This figure uses UML notation, which is well known in the art.

Here we can see that there are zero or more Views 102 that are associated with a Model 104 via the model association 106. The Model 104 contains zero or more Model Elements 108. Similarly the View 102 contains zero or more View Elements 110. Each View Element 110 is associated with a Model Element 108. There may be many View Elements 110 for each Model Element 108.

View Elements 110 usually correspond to diagrammatic elements that are rendered in the display area. The View elements 110 typically record details of the position, color and shape of the corresponding diagrammatic element. The View elements 110 may also reflect information contained within their corresponding model element 108 such as a unique name, or adopt an appearance based upon properties of the corresponding model element 108.

The types of Model Elements 108 that can be incorporated within a Model 104 is governed by a meta-model. For example, representing a UML model entails Model Element types corresponding to Class, Package and Association, among other types.

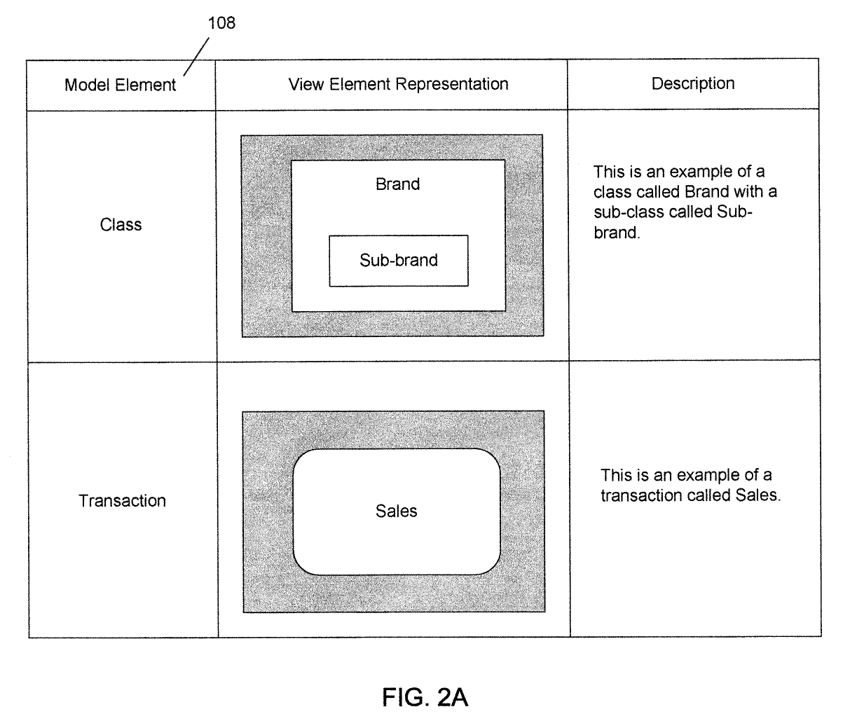

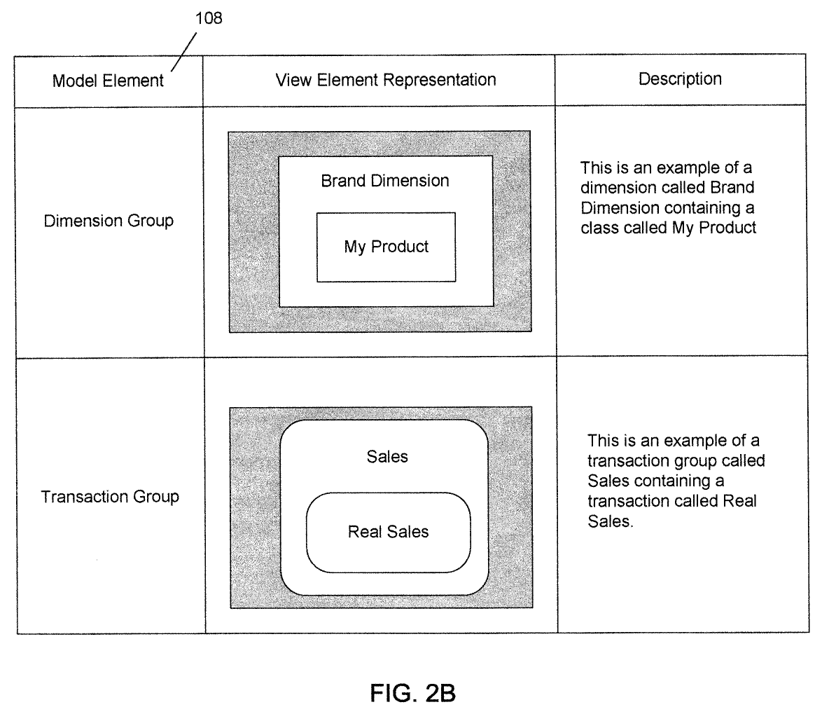

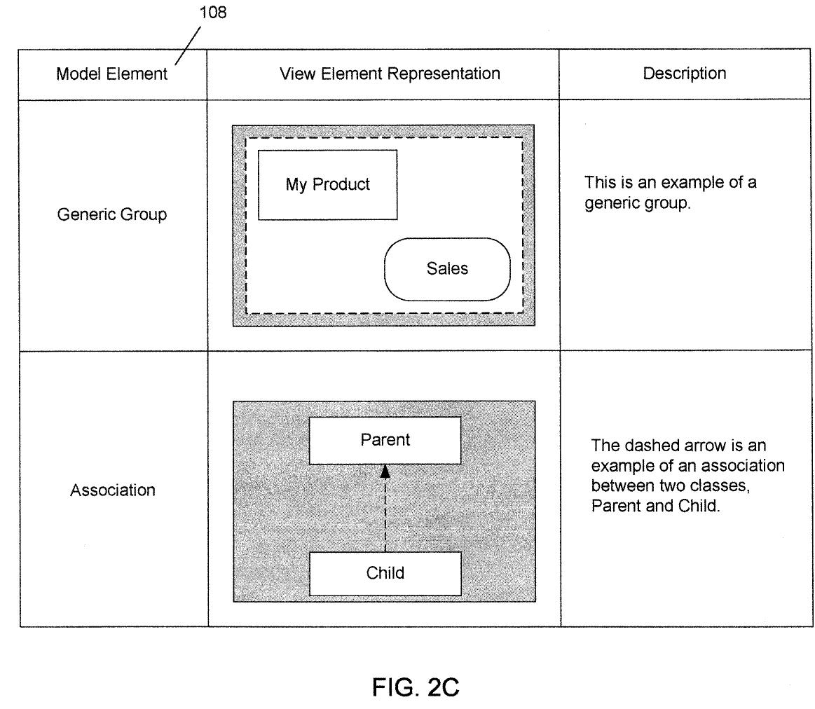

The tables of FIGS. 2A-2C illustrate the relationship between Model Element 108 and its View Element Representation for one particular proprietary business model notation. The View Element Representations are shown instantiated within a diagram area (also referred to herein as the display area). The display area is depicted in FIGS. 2A-2C by a shaded area bounded by a solid line, and is not part of the view element representation being shown.

When a gesture is completed within the diagram area, computer software interprets the gesture to determine which View Element and corresponding Model Element should be added to the View and Model respectively. This is described in the following sub-section.

Although many of the exemplary embodiments herein contemplate individual gestures, it should be understood that multiple gestures may also be used to specify a model. Similarly, while many of the exemplary embodiments herein describe gestures consisting of a single stroke, a gesture can consist of compound strokes.

### Gesture Detection and Identification

In the exemplary embodiment described, gestures are captured through use of the right button on a two button mouse, since the left mouse button by convention is used for representing operations such as selecting, grouping and dragging View Elements. The described embodiment captures a stroke represented by the straight line depicted from when the user depresses the right mouse button to the end location when the user releases the right mouse button. While the mouse button is depressed, the described embodiment provides a visual cue to the user for the stroke being created, by drawing a pale line or rectangle from the start location to the tip of the mouse pointer.

In general, gestures are input to the computer via an information input device. In the described embodiments, the information input device is a two-button mouse, although in alternative embodiments the information input device may take other forms. For example, the information input device may include an electronic pen operating in conjunction with an electronic white board or the computer display, a touch-sensitive display screen, a wireless or wired motion/position sensor, or an optical encoder, to name a few.

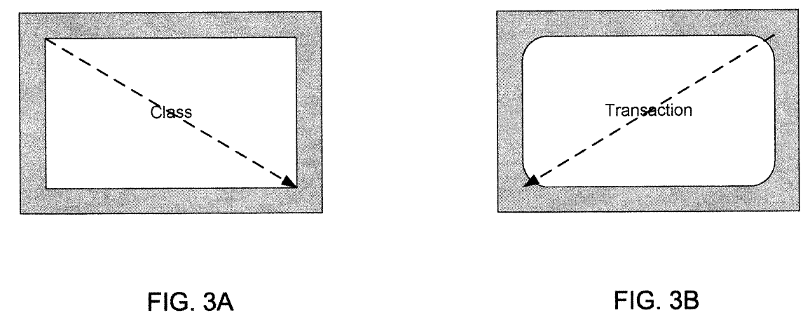

The described embodiment operates by interpreting user-input gestures as follows. Computer software determines the orientation of the stroke. The computer software creates a class if the stroke is from left to right, or a transaction if the stroke is from right to left. The class or transaction is created so that its diagonal dimension presented in the display area is equal to the stroke. For example, FIG. 3A illustrates the gesture for creating a class within a model and FIG. 3B illustrates the gesture for creating a transaction within a model. The diagonal dashed line represents the direction of the stroke gesture starting from the tail of the arrow and finishing at the tip of the arrow head. These are only exemplary gestures, and other unique gestures may also be used to create classes and transactions. The point of this example is that a gesture with one particular stroke orientation is associated with a class, and a gesture with a different particular stroke orientation is associated with a transaction.

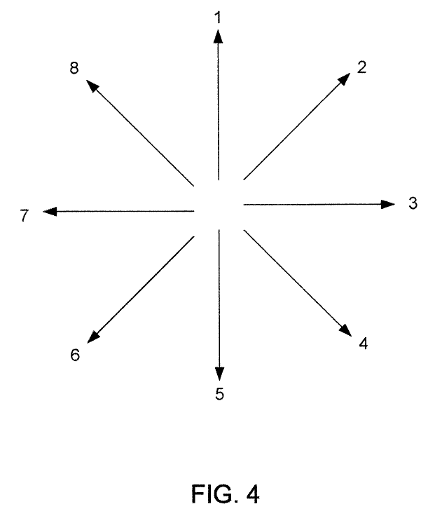

Note that this exemplary embodiment is only sensitive to the horizontal direction of the stroke gesture. However, an alternative embodiment that determines and uses the vertical direction (i.e., the vertical component) of the stroke can identify other unique stroke orientations, such as the eight unique orientations shown in FIG. 4.

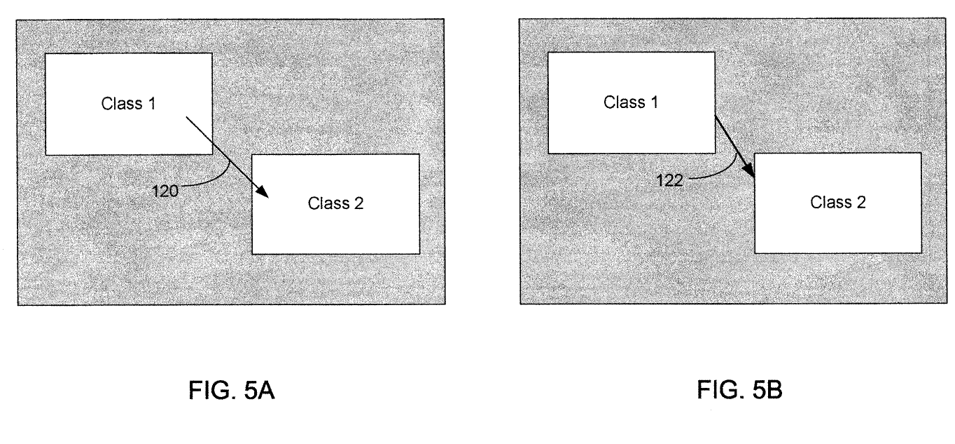

In determining the gesture, the described embodiment further determines the context of the start location and the context of the end location. If the gesture is started within a pre-existing View Element, such as a class or a transaction, and ends within either a class or a transaction, computer software interprets the gesture in a particular manner. This particular context creates an association between two classes, as shown in FIGS. 5A and 5B.

Notice how in FIG. 5A, the gesture 120 is started within Class 1 and finished within Class 2. The computer software identifies this context and inserts an association 122 whose path corresponds to the direction of the gesture and intersects the edges of Class 1 and Class 2, as shown in FIG. 5B.

When the gesture is performed coincident to other input, for example the depression of the CTRL key, the gesture is interpreted differently. The different kinds of group shown in FIGS. 2B and 2C are created if the stroke gesture is performed and completed while holding down the CTRL key. The type of group one of dimension, transaction and generic is determined from the View Elements enclosed by the rectangle representing the group.

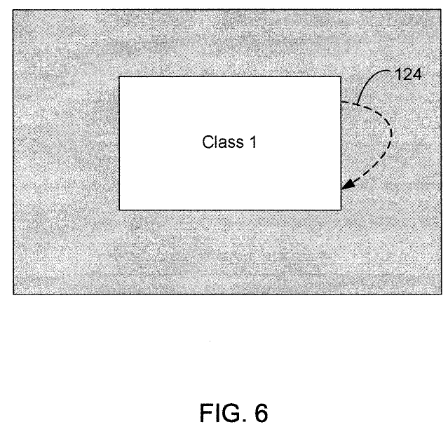

An involution or reflexive association 124 is identified if the start and end locations of the gesture are contained within the same class and the CTRL key is depressed, as shown in FIG. 6.

By using coincident input through the depression of computer keyboard keys, hundreds of unique gestures can be identified. Just using the twenty six letters of the alphabet and the eight different orientations shown in FIG. 3 would allow two hundred and eight gesture interpretations for instance, many more than would be practically necessary. This variety of interpretations is exemplary only—the described embodiment requires only a few different coincident input keys. A useful aspect of the described inventions is that a relatively small group of gestures can be used intuitively to create a graphical representation of a model.

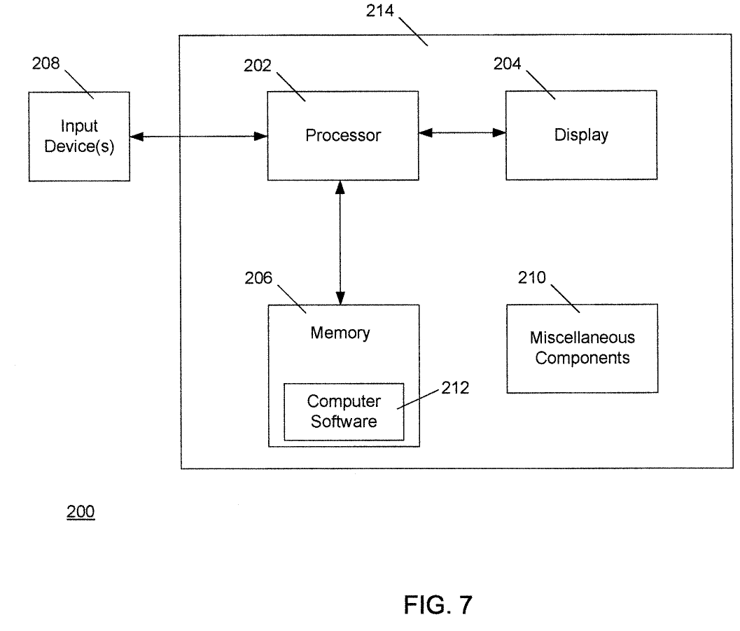

FIG. 7 shows an example of a computer 200 upon which the described embodiments are implemented. The computer 200 includes a processor 202, a display 204, memory 206 for storing computer software 212, input devices 208, miscellaneous components 210, and a housing 214 for containing some or all of the constituent components. These miscellaneous components 210 include items necessary for operation of the computer, such as printed circuit boards, electronic devices, wires and cables, firmware and such. Detailed description of the miscellaneous components 210 is omitted because they are well known to one skilled in the art.

Although specific examples of these components are described herein, it should be understood that they do not limit the invention, and that other particular components may be used to fulfill the described functionality. Further, it should be understood that the computer 200 itself may take other forms, such as a laptop computer, a desktop computer, a distributed computing system, a handheld computer, and other platforms capable of implementing the functionality of the described embodiments.

In this example, the computer 200 is a Dell Precision 490 desktop computer. The processor 202 is an Intel Xeon CPU running at 3 GHz. The display 204 is a Samsung SyncMaster 740B flat screen monitor with a resolution of 1280 by 1024 pixels and 32 bit color quality. The display 204 works in conjunction with a NVIDIA Quadro NVS 285 graphics card (not shown). The memory 206 includes at least 2 GB of RAM and 50 GB Hard-disk drive device. The input devices include at least a standard Dell optical mouse and keyboard. The computer software 212, which implements the described embodiments when executed by the processor, is written in C# using the .NET 3.0 framework for use with Microsoft Windows XP and Windows Vista. The operating system of the computer 200 is Microsoft Windows XP. The operating system is also stored within the memory 206.

### Further Applications

This gesture based approach may be applied to other types of business models including the definition of business process and workflow models. This approach can be applied to the creation of UML models.

Alternative embodiments can combine more than one stroke to increase the range of business model elements that can be created. Adopting a single stroke model limits the number of different elements that can be created based upon context, orientation and coincident input.

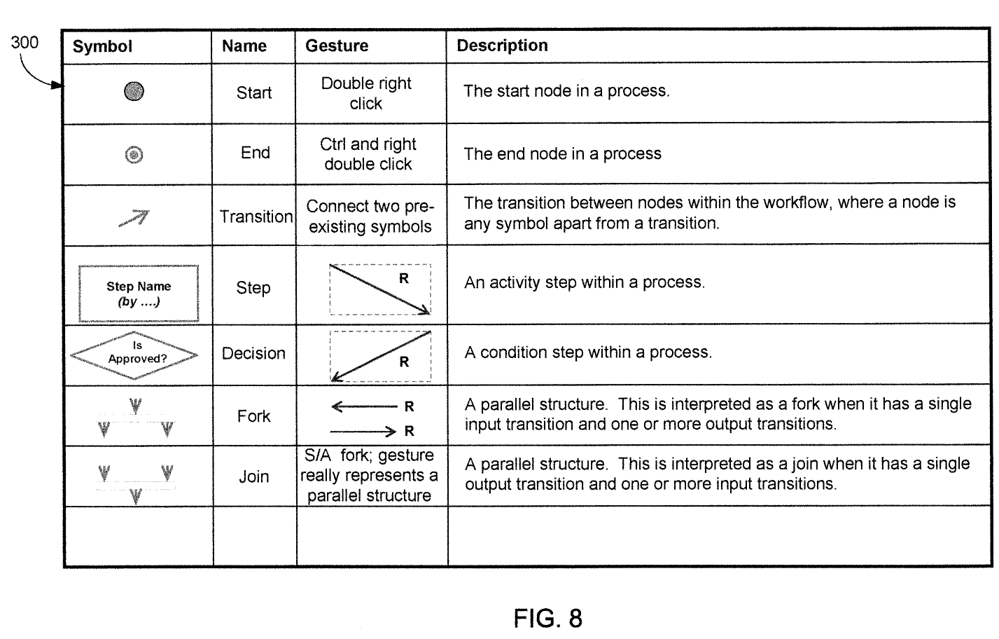

The described embodiments may be used to represent business process and workflow functionality, as shown in FIG. 8. Each row of FIG. 8 shows a business process/workflow model element with a graphical representation (i.e., a symbol), a model name, a gesture for instantiating the graphical representation, and a description of the model and its functionality. For example, the first row 300 relates to a start node model of a business process/workflow. The graphical illustration (i.e., symbol) is a circle with its interior shaded, which is instantiated with a double click gesture.

Note that the “R” next to the arrow in the gesture column for the Step, Decision and Fork model elements (and inherently for the Join model element, since its gesture is the same as the gesture for the Fork) means that the right mouse button is depressed while the gesture is performed in the direction of the arrow.

The model structure FIG. 8 illustrates is exemplary only. Other gestures, symbols and model characteristics can be used to represent the desired business process and workflow functionality.

The described embodiments relating to business models are not meant to limit the underlying concepts described herein. The described embodiments may also be applied to creating models other than business models, for example electronic circuit models, models of mechanical structures, and biological models, to name a few.

The invention may be embodied in other specific forms without departing from the spirit or essential characteristics thereof. The present embodiments are therefore to be considered in respects as illustrative and not restrictive.

What is claimed is:

1. A method of using a gesture to create a model presented in a display area, wherein the gesture is computer readable, comprising:
performing the gesture such that two or more characteristics associated with the gesture are input to a computer along with the gesture, wherein at least one of the characteristics includes a context of the gesture with respect to objects within the display area, and at least one of the characteristics includes an orientation of the gesture with respect to the display area;
mapping, by the computer, the gesture and the two or more characteristics to one or more model elements;
creating the model by accumulating the one or more model elements, wherein the model conforms to a meta-model; and,
presenting the model in the display area.

2. The method of claim 1, further including providing at least one additional input to the computer while performing the gesture, and mapping the at least one additional input to the at least one model attribute along with the gesture and the two or more characteristics.

3. The method of claim 1, further including performing the gesture with an information input device.

4. The method of claim 3, wherein the information input device is a mouse.

5. The method of claim 1, wherein presenting the model in the display area further includes rendering each view element within a view in the display area.

6. The method of claim 5, wherein the view element representation of the model includes at least one of position, color, texture, shading and shape of constituent diagrammatic elements of the view element representation.

7. The method of claim 5, wherein the view element representation of the model includes information relating to the corresponding model such as a unique name or an appearance characteristic.

8. The method of claim 1, wherein the mapping further includes determining context of a start location and an end location, and establishing a relationship between elements of the model according to the context.

9. The method of claim 1, wherein the model is a business model.

10. The method of claim 1, further including performing at least one additional gesture, and mapping the gesture, the additional gesture, and the two or more characteristics to an alternative model attribute for use in creating the model.

11. A system for creating a model from a gesture performed by a user, and presenting the model in a display area, wherein the gesture is computer readable, comprising:
a computing device having at least a processor, a display, and a memory device;
an input device with which the user performs the gesture, wherein the input device provides two or more characteristics associated with the gesture to the computing device along with the gesture, at least one of the characteristics includes a context of the gesture with respect to objects within the display area, and at least one of the characteristics includes an orientation of the gesture with respect to the display area;
wherein the computing device:
(i) maps the gesture and the two or more characteristics to at one or more model elements;
(iii) creates the model by accumulating the one or more model elements, wherein the model conforms to a meta-model; and,
(iv) presents the model in the display area.

12. The system of claim 1, further including an additional input device for accepting at least one additional input from the user to the computer while performing the gesture, wherein the computing device maps the at least one additional input to the at least one model attribute along with the gesture and the two or more characteristics.

13. The system of claim 11, wherein the user performs the gesture with an information input device.

14. The system of claim 13, wherein the information input device is a mouse.

15. The system of claim 11, wherein the computing device presents the model in the display area by rendering each view element within a view in the display area.

16. The system of claim 15, wherein the view element representation of the model includes at least one of position, color, texture, shading and shape of constituent diagrammatic elements of the view element representation.

17. The system of claim 15, wherein the view element representation of the model includes information relating to the corresponding model such as a unique name or an appearance characteristic.

18. The system of claim 11, wherein the computing device further determines context of a start location and an end location, and establishes a relationship between elements of the model according to the context.

19. The system of claim 11, wherein the model is a business model.

20. The method of claim 11, wherein the computing device further receives at least one additional gesture, and maps the gesture, the additional gesture, and the two or more characteristics to an alternative model attribute for use in creating the model.
